(19) United States
(12) Patent Application Publication
(10) Pub. No.: US 2021/0390001 A1
(43) Pub. Date: Dec. 16, 2021

(54) TECHNIQUES FOR TRANSFERRING DATA WITHIN AND BETWEEN COMPUTING ENVIRONMENTS

(71) Applicant: Capital One Services, LLC, McLean, VA (US)

(72) Inventors: Austin Grant WALTERS, Savoy, IL (US); Jeremy Edward GOODSITT, Champaign, IL (US); Anh TRUONG, Champaign, IL (US)

(73) Assignee: Capital One Services, LLC, McLean, VA (US)

(21) Appl. No.: 16/902,939

(22) Filed: Jun. 16, 2020

(51) Int. Cl. G06F 9/54; G06F 21/62; G06F 3/0481; G06F 40/30; G06F 5/06; G06N 20/00

(52) U.S. Cl. CPC G06F 9/543; G06F 21/6245; G06N 20/00; G06F 40/30; G06F 5/06; G06F 3/0481

(57) ABSTRACT

Various embodiments are generally directed to techniques for transferring data within and between computing environments with a text interaction system (TIS), such as by identifying and classifying objects of interest in target data, for instance. Some embodiments are particularly directed to projecting a use and/or destination for text copied to a clipboard datastore. Various embodiments are directed to identifying relevant text in selection input. Many embodiments are directed to utilizing contextual data for one or more of determining objects of interest, classifying objects of interest, and determining output to provide via a graphical user interface (GUI).

### BACKGROUND

Transferring data within and between computing environments may include recording data from a first location and providing the data to a second location. For example, text from a first location in a graphical user interface (GUI) can be cut or copied and then pasted in a second location in the GUI based on user input. More generally, in human-computer interaction and user interface design, cut, copy and paste are related commands that offer an interprocess communication technique for transferring data through a computer's user interface. The cut command may remove selected data from its original position, while the copy command creates a duplicate; however, in both cases the selected data is kept in temporary storage (i.e., clipboard datastore or clipboard). The data from the clipboard may later be inserted wherever a paste command is issued. Typically, the data may remain available to any application supporting the feature, thus allowing easy data transfer between applications.

### SUMMARY

This summary is not intended to identify only key or essential features of the described subject matter, nor is it intended to be used in isolation to determine the scope of the described subject matter. The subject matter should be understood by reference to appropriate portions of the entire specification of this patent, any or all drawings, and each claim.

Various embodiments described herein may include an apparatus comprising a processor and memory comprising instructions that when executed by the processor cause the processor to perform operations comprising one or more of: identify target text based on first input received in a first environment presented via a graphical user interface (GUI); determine two or more objects of interest in the target text based on analysis of the target text with one or more machine learning algorithms; assign one or more classifications to each of the two or more objects of interest in the target text based on analysis of the target text with the one or more machine learning algorithms; store indications of the two or more objects of interest in a clipboard datastore based on second input received in the first environment presented via the GUI; store indications of the one or more classifications of each of the two or more objects of interest in the clipboard datastore based on the second input received in the first environment presented via the GUI; present, via the GUI, a first classification assigned to a first object of interest of the one or more objects of interest and a second classification assigned to a second object of interest of the one or more objects of interest based on third input received in a second environment presented via the GUI; and insert the first object of interest into the second environment presented via the GUI based on fourth input received in the second environment presented via the GUI.

In some embodiments, the memory includes instructions that when executed by the processor cause the processor to perform operations comprising one or more of: identify first contextual data for the first environment; determine the two or more objects of interest in the target text based on analysis of the target text and the first contextual data with the one or more machine learning algorithms; and assign the one or more classification to each of the two or more objects of interest in the target text based on analysis of the target text and the first contextual data with the one or more machine learning algorithms.

In many embodiments, the memory includes instructions that when executed by the processor cause the processor to perform operations comprising one or more of: identify second contextual data for the second environment; present, via the GUI, the first classification assigned to the first object of interest of the one or more objects of interest and the second classification assigned to the second object of interest of the one or more objects of interest based on the third input and the second contextual data; and insert the first object of interest into the second environment based on fourth input and the second contextual data.

In several embodiments, the memory includes instructions that when executed by the processor cause the processor to perform operations comprising one or more of: determine a setting associated with the first environment; compare the setting associated with the first environment to the first classification of the first object of interest of the two or more objects of interest; and store the indications of the first object of interest in the clipboard datastore based on comparison of the setting associated with the first environment and the first classification of the first object of interest. In several such embodiments, the setting associated with the first environment may comprise a privacy privilege associated with the first environment and the first classification of the first object of interest may comprise a privacy level associated with the first object of interest. In further such embodiments, the first object of interest may comprise an account number or a social security number.

In one or more embodiments, the memory includes instructions that when executed by the processor cause the processor to perform operations comprising one or more of: determine a setting associated with the first environment; compare the setting associated with the first environment to a classification of a third object of interest determined in the target text; and present, via the GUI, that indications of the third object of interest are blocked from storage in the clipboard datastore based on comparison of the setting associated with the first environment and the classification of the third object of interest.

In various embodiments, the memory includes instructions that when executed by the processor cause the processor to perform operations comprising one or more of: determine a setting associated with the second environment; compare the setting associated with the second environment to the first classification of the first object of interest of the two or more objects of interest; and insert the first object of interest into the second environment presented via the GUI based on comparison of the setting associated with the second environment and the first classification of the first object of interest.

In some embodiments, the memory includes instructions that when executed by the processor cause the processor to perform operations comprising one or more of: determine a setting associated with the second environment; compare the setting associated with the second environment to a classification of a third object of interest determined in the target text; and present, via the GUI, that indications of the third object of interest are blocked from insertion into the second environment based on comparison of the setting associated with the second environment and the classification of the third object of interest.

In many embodiments, the memory includes instructions that when executed by the processor cause the processor to perform operations comprising store indications of the two or more objects of interest to a first in, first out (FIFO) data structure in the clipboard datastore. In several embodiments, the first environment may comprise a first application and the second environment may comprise a second application, wherein the first application is different than the second application. In one or more embodiments, the first environment may comprise a first window associated with an application and the second environment may comprise a second window associated with the application.

One or more embodiments described herein may include at least one non-transitory computer-readable medium comprising a set of instructions that, in response to being executed by a processor circuit, cause the processor circuit to perform operations comprising one or more of: identify target text based on first input received in a first environment presented via a graphical user interface (GUI); determine two or more objects of interest in the target text based on analysis of the target text with one or more machine learning algorithms; assign one or more classifications to each of the two or more objects of interest in the target text based on analysis of the target text with the one or more machine learning algorithms; store indications of the two or more objects of interest in a clipboard datastore based on second input received in the first environment presented via the GUI; store indications of the one or more classifications of each of the two or more objects of interest in the clipboard datastore based on the second input received in the first environment presented via the GUI; present, via the GUI, first and second classifications assigned to a first object of interest of the one or more objects of interest based on third input received in a second environment presented via the GUI; and insert the first object of interest into the second environment presented via the GUI based on fourth input received in the second environment presented via the GUI.

In some embodiments, the at least one non-transitory computer-readable medium may comprise instructions that, in response to being executed by the processor circuit, cause the processor circuit to store indications of the two or more objects of interest to a first in, first out (FIFO) data structure in the clipboard datastore. In several embodiments, the first environment may comprise a first application and the second environment may comprise a second application, wherein the first application is different than the second application. In multiple embodiments, the first environment may comprise a first window associated with an application and the second environment may comprise a second window associated with the application.

Several embodiments described herein may include a computer-implemented method, comprising one or more of: identifying target text based on first input received in a first environment presented via a graphical user interface (GUI); determining two or more objects of interest in the target text based on analysis of the target text with one or more machine learning algorithms; assigning one or more classifications to each of the two or more objects of interest in the target text based on analysis of the target text with the one or more machine learning algorithms; storing indications of the two or more objects of interest in a clipboard datastore based on second input received in the first environment presented via the GUI; storing indications of the one or more classifications of each of the two or more objects of interest in the clipboard datastore based on the second input received in the first environment presented via the GUI; presenting, via the GUI, first and second objects of interest of the one or more objects of interest assigned to a first classification based on third input received in a second environment presented via the GUI; and inserting the first and second objects of interest into the second environment presented via the GUI based on fourth input received in the second environment presented via the GUI.

In some embodiments, the computer-implemented method comprises one or more of: determining a setting associated with the first environment; comparing the setting associated with the first environment to the first classification of the first object of interest of the two or more objects of interest; and storing the indications of the first object of interest in the clipboard datastore based on comparison of the setting associated with the first environment and the first classification of the first object of interest.

In many embodiments, the computer-implemented method comprises one or more of: determining a setting associated with the first environment; comparing the setting associated with the first environment to a classification of a third object of interest determined in the target text; and presenting, via the GUI, that indications of the third object of interest are blocked from storage in the clipboard datastore based on comparison of the setting associated with the first environment and the classification of the third object of interest. In several embodiments, the computer-implemented method comprises one or more of: determining a setting associated with the second environment; comparing the setting associated with the second environment to the first classification of the first object of interest of the two or more objects of interest; and inserting the first object of interest into the second environment presented via the GUI based on comparison of the setting associated with the second environment and the first classification of the first object of interest.

### BRIEF DESCRIPTION OF THE DRAWINGS

FIG. 1 illustrates an exemplary operating environment for a text interaction system according to one or more embodiments described herein.

FIG. 2 illustrates various aspects of an exemplary text interaction system according to one or more embodiments described herein.

FIG. 3 illustrates an exemplary text interaction manager according to one or more embodiments described herein.

FIG. 4 illustrates various aspects of an exemplary text interaction manager according to one or more embodiments described herein.

FIG. 5A illustrates a first exemplary logic flow according to one or more embodiments described herein.

FIG. 5B illustrates a second exemplary logic flow according to one or more embodiments described herein.

FIG. 5C illustrates a third exemplary logic flow according to one or more embodiments described herein.

FIG. 6 illustrates exemplary aspects of a computing architecture according to one or more embodiments described herein.

FIG. 7 illustrates exemplary aspects of a communications architecture according to one or more embodiments described herein.

### DETAILED DESCRIPTION

Various embodiments are generally directed to techniques for transferring data within and between computing environments with a text interaction system (TIS), such as by identifying and classifying objects of interest in target data, for instance. Some embodiments are particularly directed to projecting a use and/or destination for text copied to a clipboard datastore. Various embodiments are directed to identifying relevant text in selection input. Many embodiments are directed to utilizing contextual data for one or more of determining objects of interest, classifying objects of interest, and determining output to provide via a graphical user interface (GUI). These and other embodiments are described and claimed.

Some challenges facing transferring data within and between computing environments with a TIS include rudimentary and rigid devices and methods for identifying, collecting, and/or transferring data between computing environments, such as different applications. For example, only a single item of data may be identified, collected, and/or transferred at the time. In another example, only entire blocks of selected text may be collected and/or transferred. Adding further complexity, different environments may require or have different security requirements. Accordingly, transferring data within and between computing environments may be unsecure and/or allow unintended access to confidential data. These and other factors may result in TISs and methods with limited capabilities, resulting in reduced applicability, poor adaptability, and limited functionality. Such limitations can drastically reduce the efficiency with which data can be transferred within and/or between computing environments.

Various embodiments described herein include text interaction systems, devices, and/or techniques for dynamic and accurate data transfer within and between computing environments. Several embodiments automatically identify and classify target data in selection input. In many embodiments, classification of the target data is utilized in projecting one or more characteristics of the data transfer (e.g., via machine learning algorithms). For example, classification of the target data may be utilized to project a destination for a data transfer. In another example, classification of the target data may be utilized to block a data transfer from a high security environment to a low security environment. Many embodiments may include mechanisms to identify relevant information, correlate and classify the information to automatically perform/project one or more aspects/characteristics of data transfers. Multiple embodiments may collect and/or utilize contextual data in one or more of the identification of relevant information, correlation and classification of the information, and automatically performing/projecting one or more aspects/characteristics of data transfers. The contextual data may be collected from various environments and/or between different portion of the same, or a different, environment.

One or more techniques described herein may enable increased adaptability, usability, and effectiveness of text interaction systems, leading to better functionality and increased capabilities. In these and other ways, components/techniques described herein may improve the data transfers within and between environments, resulting in several technical effects and advantages over conventional computer technology, including increased capabilities and improved adaptability. In various embodiments, one or more of the aspects, techniques, and/or components described herein may be implemented in a practical application via one or more computing devices, and thereby provide additional and useful functionality to the one or more computing devices, resulting in more capable, better functioning, and improved computing devices. Further, one or more of the aspects, techniques, and/or components described herein may be utilized to improve one or more technical fields including one or more of enterprise systems, environmental data transfers, user interface design, human-computer interaction, interprocess communication, user satisfaction, and/or machine learning algorithms.

In several embodiments, components described herein may provide specific and particular manners to improve and/or automate aspects of data transfers between and/or among different environments, or portions thereof. In various embodiments, the specific and particular manners may include, for instance, identifying and classifying target data in selection input. In many embodiments, the specific and particular manners may include, for instance, projecting a destination of a data transfer based on one or more classifications assigned to objects of interest identified in selection input. In some embodiments, contextual data may be utilized to determine one or more characteristics of a data transfer. For instance, contextual data may be utilized to identify target words in selection input. In some such instances, contextual data comprising ‘account number’ proximate a numerical string of text may indicate the numerical string of text is an account number.

In many embodiments, one or more of the components described herein may be implemented as a set of rules that improve computer-related technology by allowing a function not previously performable by a computer that enables an improved technological result to be achieved. In several embodiments, the function allowed may include one or more aspects of transferring data among and/or between environments, or portions thereof. For example, contextual data from an origin environment may indicate the origin environment is an online banking application, and the STS may classify thirteen digit numbers of form ‘000123XXXXXXX’ as checking account numbers and thirteen digit numbers of form ‘000987XXXXXXX’ as savings account numbers. In a some such examples, the STS may determine text proximate a checking account number is relevant contextual data, (e.g., and classify as name of the checking account). In various such examples, the STS may classify text in the header is a bank name. Continuing with the previous example, the STS may propose inserting the checking account number in a destination environment based on a contextual data from the destination environment indicating the destination environment is an autodraft enrollment for a checking account.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatuses may be specially constructed for the required purpose or may include a general-purpose computer. The required structure for a variety of these machines will be apparent from the description given.

Reference is now made to the drawings, wherein like reference numerals are used to refer to like elements throughout. In the following description, for purpose of explanation, numerous specific details are set forth in order to provide a thorough understanding thereof. It may be evident, however, that the novel embodiments can be practiced without these specific details. In other instances, well known structures and devices are shown in block diagram form to facilitate a description thereof. The intention is to cover all modification, equivalents, and alternatives within the scope of the claims.

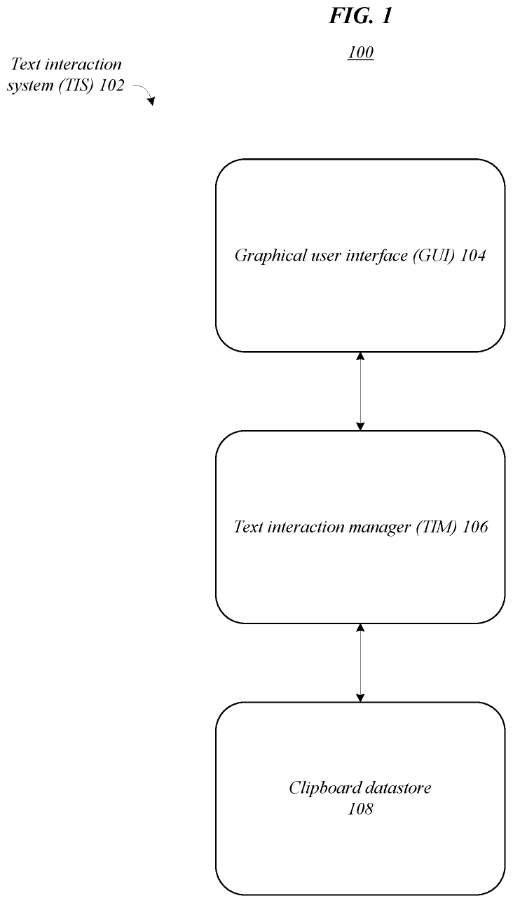

FIG. 1 illustrates an exemplary operating environment 100 for a text interaction system (TIS) 102 according to one or more embodiments described herein. In some embodiments, environment 100 may include one or more components that are the same or similar to one or more other components described herein. The TIS 102 of operating environment 100 may include a graphical user interface 104, a text interaction manager (TIM) 106, and a clipboard datastore 108. In one or more embodiments described herein, TIM 106 may facilitate data transfers implemented based on user input received via GUI 104. TIM 106 may utilize clipboard datastore 108 to store one or more portions of data for transfer. Embodiments are not limited in this context.

In various embodiments, one or more components of TIS 102 may interoperate to provide copy/cut and paste functionality. In many embodiments, TIM 206 may provide automatic, suggestive, and/or predictive features to data transfers. For example, TIM 206 may utilize machine learning to predict a destination for a data transfer. In several embodiments, TIM 206 may classify and/or identify the target of a data transfer. For example, TIM 206 may identify objects of interest (e.g., target words) in a highlighted/selected block of text. Further, TIM 206 may determine an identified object of interest includes a bank account number. Still further, TIM 206 may identify a destination for the object of interest as a GUI interface element that accepts a number with the same number of digits as the bank account number.

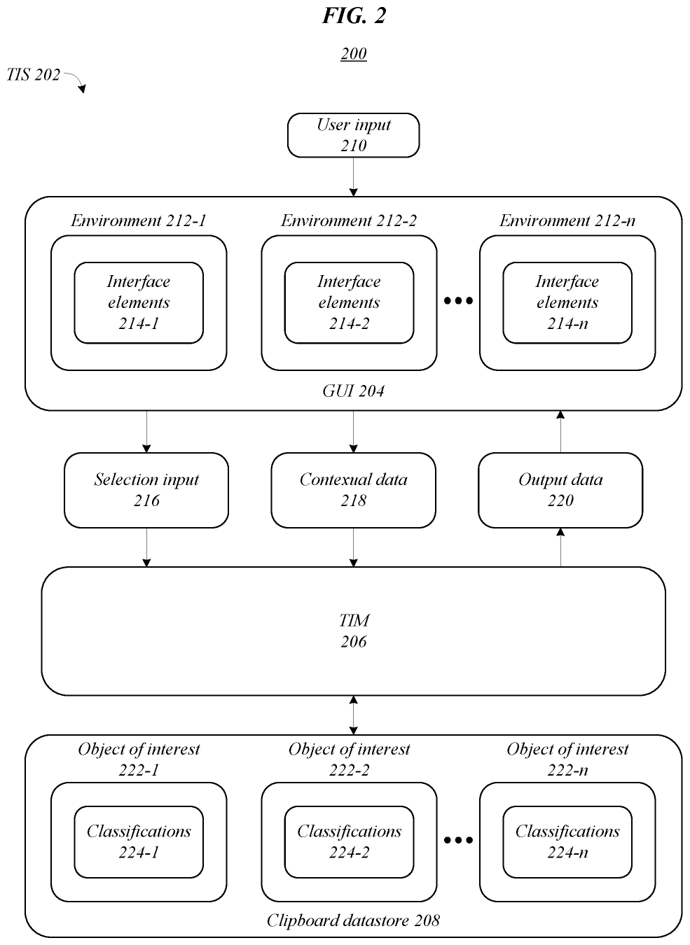

FIG. 2 illustrates various aspects of an exemplary TIS 202 in operating environment 200 according to one or more embodiments described herein. In some embodiments, environment 200 may include one or more components that are the same or similar to one or more other components described herein. For example, clipboard datastore 208 may be the same or similar to clipboard datastore 108. In environment 200, TIS 202 may include GUI 204 receiving user input 210. The GUI 204 may include one or more environments 212-1, 212-2, 212-n (or environments 212), each with one or more interface elements 214-1, 214-2, 214-n (or interface elements 214). The operating environment 200 illustrates selection input 216 and contextual data 218 moving from the GUI 204 to TIM 206, and output data 220 moving from TIM 206 to GUI 204. Clipboard datastore 208 may include one or more objects of interest 222-1, 222-2, 222-n (or objects of interest 222), each with one or more classifications 224-1, 224-2, 224-n (or classifications 224). In one or more embodiments described herein, TIM 206 may facilitate data transfers implemented based on user input received via GUI 204, such as by providing copy and paste functionality. TIM 206 may utilize clipboard datastore 208 to store one or more portions of data for transfer. In some embodiments, TIM 206 may store and/or classify objects of interest in clipboard datastore 208. Embodiments are not limited in this context.

In many embodiments, GUI 204 may include one or more environments 212 with one or more interface elements 214. The environments 212 and interface elements 214 may be interacted with based on user input 210. For example, environment 212-1 may include a web browser and environment 212-2 may include a spreadsheet application. Further, one of the interface elements 214-1 in the web browser may include texting indicating an access code for privileged features in the spreadsheet application. In one or more embodiments, TIM 206 may determine the access code is an object of interest 222-1 in selection input 216 (which may include a highlighted portion of text in environment 212-1). In one or more such embodiments, TIM 206 may assign an access code classification (e.g., one of classifications 224-1) to the object of interest 222-1. One or more of identifying the object of interest 222-1 and classifying the object of interest 222-1 may be performed based on contextual data 218 and/or machine learning. For example, contextual data 218 may include a web address for a spread sheet company and text indicating that an access code for the spread sheet application is being provided. In another example, TIM 206 may block a data transfer based on contextual data 218. For instance, contextual data 218 may indicate that a target destination for data includes a website known for malicious activity. In such instances, TIM 206 may prevent data, such as an access code, from being transferred to the website known for malicious activity.

More generally, environments 212 may include various computing environments in which, or between which, copy/cut and paste operations are advantageous. For example, environment 212-1 may include an operating system interface, environment 212-2 may include a first UI window (e.g., a first web browser window or tab) and environment 212-n may include a second UI window (e.g., a second web browser window or tab). In such examples, TIM 206 may be utilized to copy/cut and paste data from a first website opened in the first UI window to a second website opened in the second UI window. In another example, environment 212-1 may include a word processor application, environment 212-2 may include a spreadsheet application, and environment 212-n may include a web portal. In such other examples, TIM 206 may be utilized to copy/cut and paste data from the word processor application and from the spreadsheet application to the web portal. In some embodiments, one or more of environments 212 may be implemented by an operating system. Interface elements 214 may include elements presented via GUI 204 that provide and/or receive data. For example, interface elements 214-n may include a first box for entering a username and a second box for entering a password. In another example, interface elements 214-2 may include a welcome screen for an online retailer. Selection input 216 may include text identified based on user input 210. For example, selection input 216 may include a block of text that is highlighted based on user input 210. In many embodiments, selection input 216 may comprise target text. Contextual data 218 may include any data indicative of a setting, situation, and/or purpose of selection input 216. In many embodiments, contextual data 218 may include metadata for the selection input 216.

In many embodiments, TIM 206 may store objects of interest 222 and one or more classifications 224 for the objects of interest 222 in clipboard datastore 208 to facilitate a data transfer. The classifications 224 may indicate one or more characteristics/attributes of an object of interest. For example, classifications 224 may include priority levels, security levels, data type, labels, and the like. In several embodiments, TIM 206 may automatically identify and/or suggest an object of interest, such as an address, bank routing number, account number (bank or otherwise), email address, social security number, passport number, driver license number, last name, license plate number, VIN number, birthdate, phone number, credit card, bank number, debit card number, and the like. In various embodiments, clipboard datastore 208 may include one or more computer-readable media utilized to transfer data, such as by providing temporary storage. In some embodiments, clipboard datastore 208 may comprise a first-in first-out queue.

In one or more embodiments, TIM 206 may provide output data 220 based on user input 210. For example, in response to selection input 216, TIM 206 may provide output data 220 requesting user input 210 to confirm one or more objects of interest and/or target words have been correctly identified and/or one or more classifications are accurate. In another example, TIM 206 may suggest a location to insert an object of interest based on user input 210 switching to environment 212-2 after copying text from environment 212-1. In yet another example, TIM 206 may, in output data 220, suggest one or more objects of interest to insert into an interface element in response to selection of the interface element. In one or more embodiments, TIM 206 may rank and/or provide confidence scores in output data 220. For instance, TIM 206 may rank objects of interest in clipboard datastore 208 to propose for insertion into an interface element. In various embodiments, TIM 206 may autocomplete one or more fields using output data 220. In one or more embodiments, TIM 206 may hide or conceal one or more portions of output data 220 for security purposes. For example, a social security number may be represented as “***-**-5487”. In several embodiments, TIM 206 may utilize machine learning (such as a neural network trained based on historical interactions) to generate output data 220.

In various embodiments, TIS 202 may perform/enable one or more of identify text highlighted based on user input, copy the text, infer what the text means (e.g., based on contextual data), assign a classification, and allow one or more portions of the text to be pasted to one or more locations. More specifically, in some embodiments, a user may be able to highlight text, right click, and copy the text; a machine learning model may predict what the text is; the text may be marked as sensitive (or not) and/or a label may be added (e.g., phone number, bank account number, etcetera); when a user right clicks to past, multiple previous copies/cuts (e.g., 10 most recent) may be presented; sensitive fields may be hidden (e.g., by ‘****’ or a label indicating what is hidden); and a user may select which field to paste. In some embodiments, TIS 202 may predict which fields should be filled based on one or more copied valves. For example, bank account and routing numbers typically come in pairs and TIS 202 may present an option to simultaneously paste the bank account and routing numbers into appropriate fields based, at least in part, on both the bank account and routing numbers being copied to the clipboard datastore 208. In some embodiments, TIS 202 may be configured for multiple users. For example, data transfers and/or preferences for multiple users may be tracked. In one or more embodiments, clipboard datastore 408 may have separate repositories for each user.

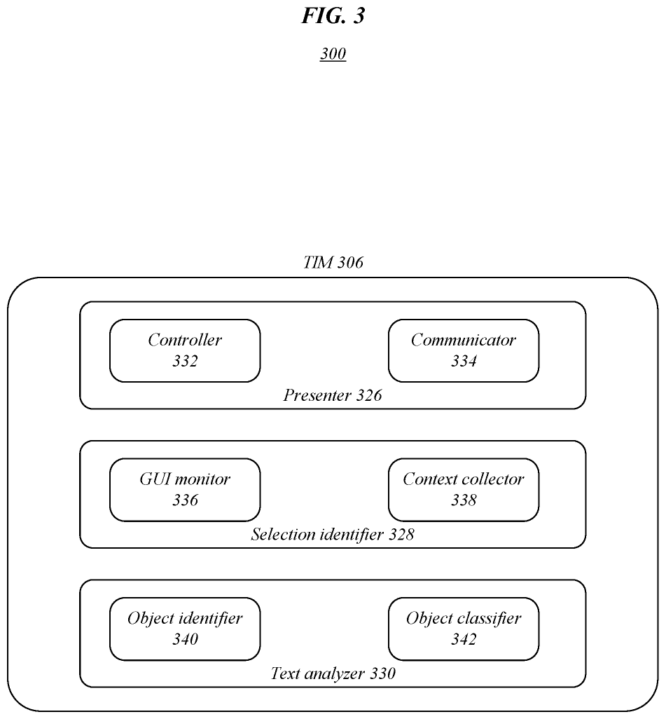

FIG. 3 illustrates text interaction manager (TIM) 306 in operating environment 300 according to one or more embodiments described herein. In some embodiments, environment 300 may include one or more components that are the same or similar to one or more other components described herein. For example, TIM 306 may be the same or similar to TIM 106. In environment 300, TIM 306 may include a presenter 326, a selection identifier 328, and a text analyzer 330. In the illustrated embodiment, presenter 326 includes controller 332 and communicator 334, selection identifier 328 includes GUI monitor 336 and context collector 338, and text analyzer 330 includes object identifier 340 and object classifier 342. In one or more embodiments described herein, TIM 306 may utilize a user interface and a clipboard datastore to implement data transfers within and/or between different computing environments. Embodiments are not limited in this context.

Presenter 326 may facilitate providing output via a GUI, such as in response to one or more of user input, selection input, and/or contextual data. More specifically, controller 332 may determine what to present via the GUI and communicator 334 may present things via the GUI. For example, controller 332 may determine which objects of interest to present via the GUI and communicator may present the objects of interest in a menu via the GUI. In a further example, controller 332 may determine to present an account number via the GUI for pasting to a target location and communicator 334 may determine to present the account number via a menu box with one or more portions of the account number hidden from view with asterisks.

Selection identifier 328 may facilitate identifying one or more of user input, selection input, and/or contextual data in/from an environment, or portion thereof. More specifically, GUI monitor 336 may identify selection input and context collector 338 may collect contextual data regarding the selection input. Text analyzer 330 may facilitate identifying objects and/or classifying objects from selection input. In many embodiments, text analyzer 330 may identify objects and/or classify objects based on one or more of user input, selection input, contextual data, historical data, and/or machine learning algorithms. More specifically, object identifier 340 may identify objects (e.g., text of interest, target words, target images, etcetera) in selection input and object classifier 342 may classify the objects identified in the selection input. In many embodiments, text analyzer 330 may interoperate with presenter 326 and/or selection identifier 328 to determine whether objects of interest and/or classifications are accurate.

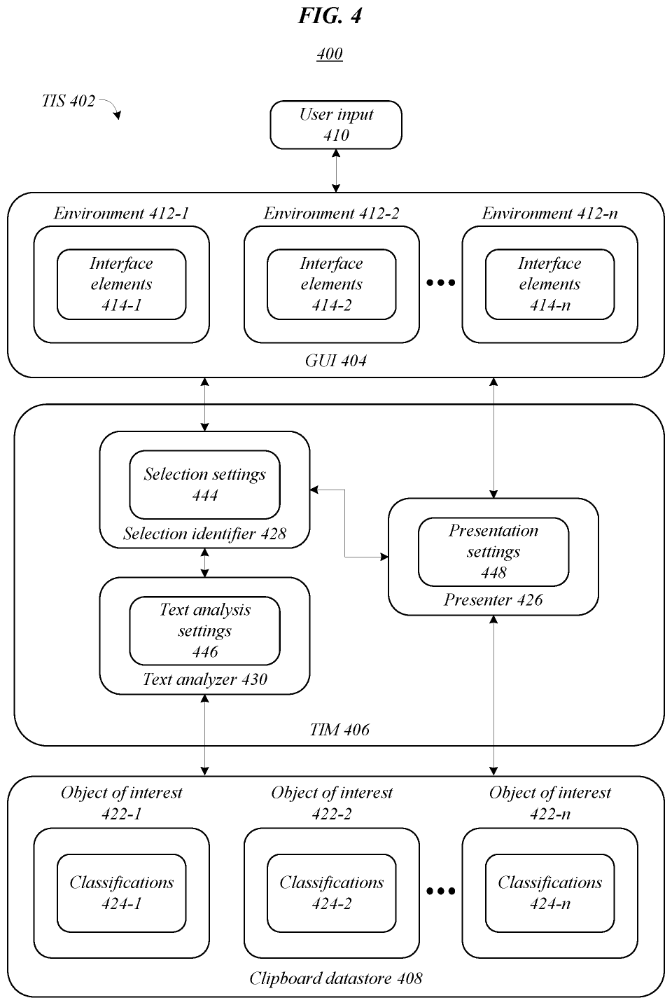

FIG. 4 illustrates various aspects of TIM 406 in operating environment 400 according to one or more embodiments described herein. In some embodiments, environment 400 may include one or more components that are the same or similar to one or more other components described herein. In environment 400, GUI 404, clipboard datastore 408, and user input 410 are illustrated with the same components as GUI 204, clipboard datastore 208, and user input 210 of FIG. 2. Accordingly, GUI 404 may include one or more environments 412-1, 412-2, 412-n, each with one or more interface elements 414-1, 414-2, 414-n, and clipboard datastore 408 may include one or more objects of interest 422-1, 422-2, 422-n, each with one or more interface elements 424-1, 424-2, 424-n. Further, TIM 406 includes selection identifier 428 with selection settings 444, text analyzer 430 with text analysis settings 446, and presenter 426 with presentation settings 448. In various embodiments, TIM 406 may include additional, or alternative components, without departing from the scope of this disclosure. Embodiments are not limited in this context.

In various embodiments, each component of TIM 406 may include one or more settings that dictate one or more aspects of their operation. For example, selection settings 444 may include one or more types of input to monitor GUI 404 for. In another example, text analysis settings 446 may include a threshold confidence level for assigning a classification to an object of interest. In yet another example, presentation settings 448 may include a text size and color to present objects of interest for pasting. In still another example, presentation settings 448 may identify how to present predicted destinations for target data. For instance, an orange bounding box may be placed around predicted target destinations.

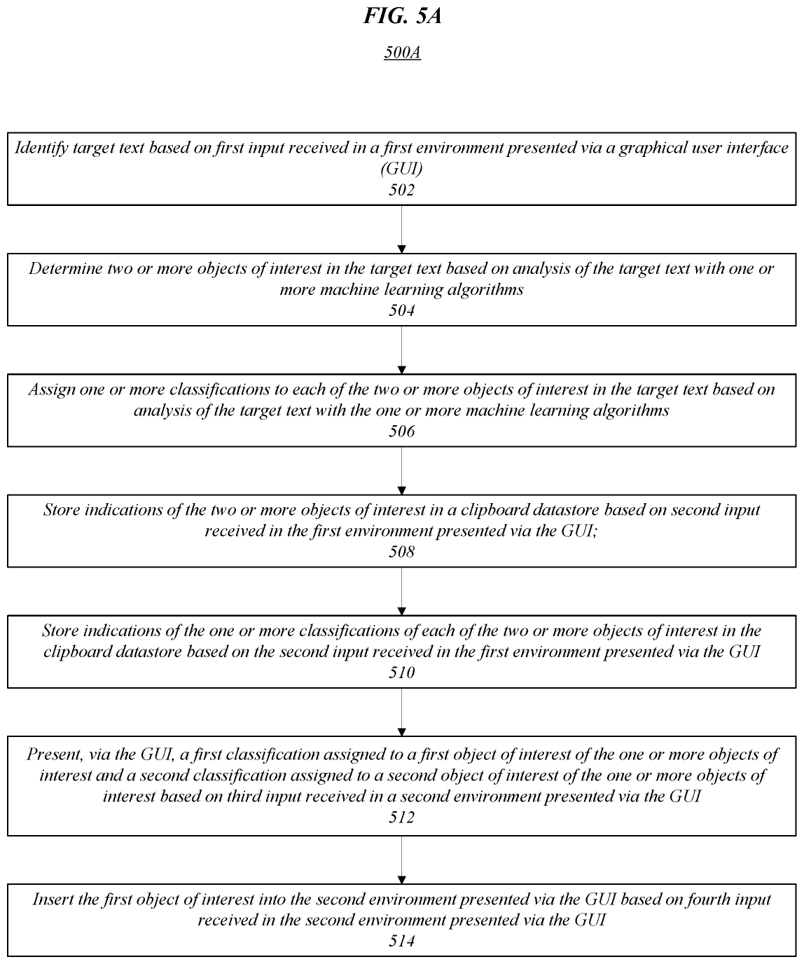

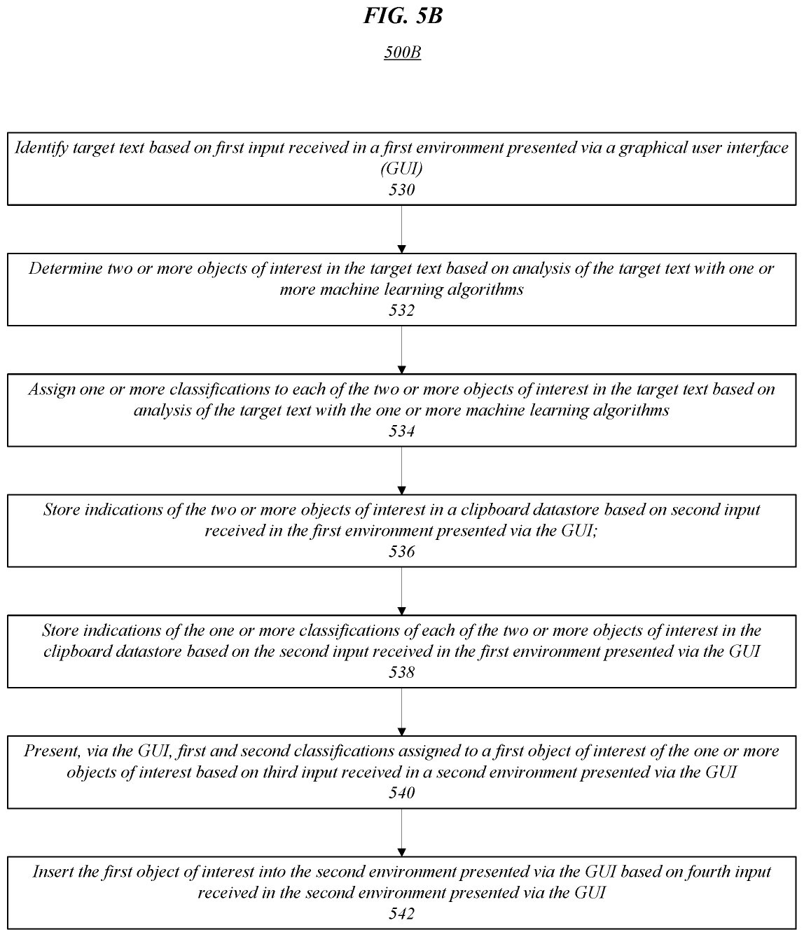

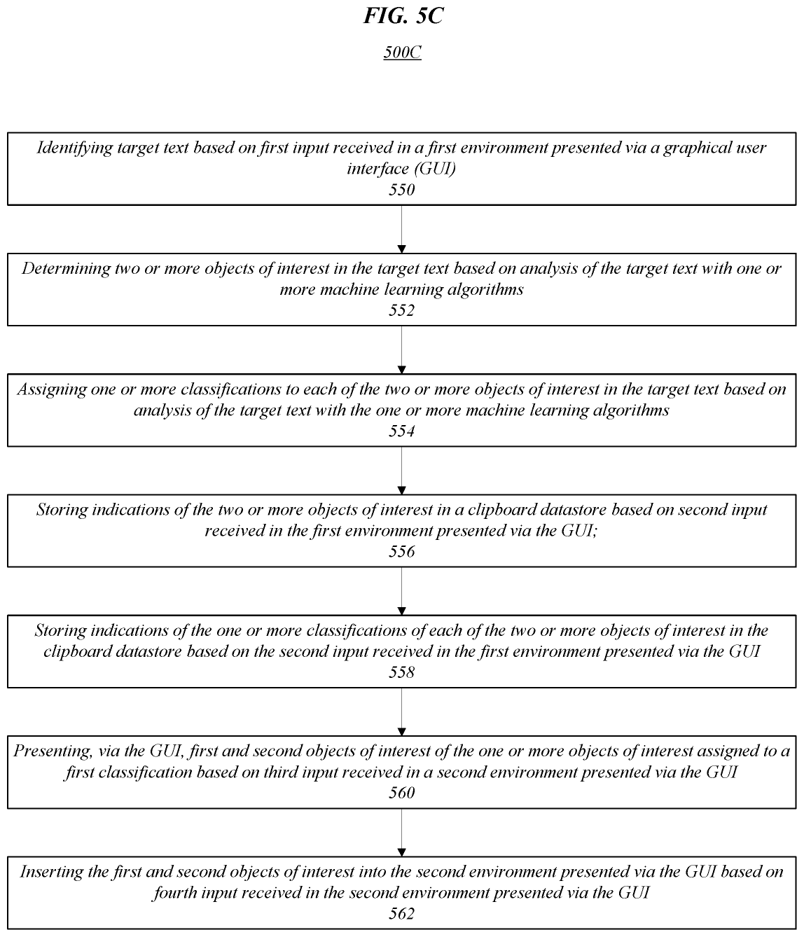

FIG. 5A illustrates one embodiment of a logic flow 500A, which may be representative of operations that may be executed in various embodiments in conjunction with techniques for transferring data within and between computing environments. The logic flow 500A may be representative of some or all of the operations that may be executed by one or more components/devices/environments described herein, such as GUI 104, TIM 106, and/or clipboard datastore 108. The embodiments are not limited in this context.

In the illustrated embodiments, logic flow 500A may begin at block 502. At block 502 “identify target text based on first input received in a first environment presented via a graphical user interface (GUI)” target text may be identified based on first input received in a first environment presented via a GUI. For example, selection input 216 comprising target text may be identified by TIM 206 based on user input 210 received in environment 212-2.

Continuing to block 504 “determine two or more objects of interest in the target text based on analysis of the target text with one or more machine learning algorithms” two or more objects of interest may be identified based on analysis of the target text with one or more machine learning algorithms. For example, objects of interest 222-1 and 222-2 may be identified in selection input 216 by TIM 206 via analysis of selection input 216 with one or more machine learning algorithms.

Proceeding to block 506 “assign one or more classifications to each of the two or more objects of interest in the target text based on analysis of the target text with the one or more machine learning algorithms” one or more classifications may be assigned to each of the two or more objects of interest in the target text based on analysis of the target text with one or more machine learning algorithms. For instance, text analyzer 430 may assign classifications 424-1 to object of interest 422-1 and classifications 424-2 to object of interest 424-2 based on analysis of selection input with one or more machine learning algorithms.

At block 508 “store indications of the two or more objects of interest in a clipboard datastore based on second input received in the first environment presented via the GUI” indications of the two or more objects of interest may be stored in a clipboard datastore based on second input received in the first environment presented via the GUI. For example, objects of interest 222-1, 222-2 may be stored in clipboard datastore 208 based on second input received in environment 212-2 via GUI 204. In some such examples, the second input may comprise user confirmation of the identified objects of interest.

At block 510 “store indications of the one or more classifications of each of the two or more objects of interest in the clipboard datastore based on the second input received in the first environment presented via the GUI” indications of the one or more classifications for each of the two or more objects of interest may be stored in the clipboard datastore based on the second input received in the first environment presented via the GUI. For example, classifications 224-1, 224-2 may be stored with objects of interest 222-1, 222-2, respectively, in clipboard datastore 208 based on second input received in environment 212-2 via GUI 204. In some such examples, the second input may comprise user confirmation of the identified objects of interest and the classifications of the identified objects of interest.

Continuing to block 512 “present, via the GUI, a first classification assigned to a first object of interest of the one or more objects of interest and a second classification assigned to a second object of interest of the one or more objects of interest based on third input received in a second environment presented via the GUI” a first classification assigned to the first object of interest and a second classification assigned to a second object of interest may be presented, via the GUI, based on third input received in a second environment presented via the GUI. For instance, presenter 426 may present object of interest 422-1 with a bank account number classification and object of interest 422-2 with a charge card account number classification in environment 212-n based on user input selecting a first interface element of interface elements 214-n.

At block 514 “insert the first object of interest into the second environment presented via the GUI based on fourth input received in the second environment presented via the GUI” the first object of interest may be inserted into the second environment presented via the GUI based on fourth input received in the second environment. For example, object of interest 422-1 with the bank account number classification may be inserted into environment 212-n based on selection of object of interest 422-1 via user input.

FIG. 5B illustrates one embodiment of a logic flow 500B, which may be representative of operations that may be executed in various embodiments in conjunction with techniques for transferring data within and between computing environments. The logic flow 500B may be representative of some or all of the operations that may be executed by one or more components/devices/environments described herein, such as GUI 104, TIM 106, and/or clipboard datastore 108. The embodiments are not limited in this context.

In the illustrated embodiments, logic flow 500B may begin at block 530. At block 530 “identify target text based on first input received in a first environment presented via a graphical user interface (GUI)” target text may be identified based on first input received in a first environment presented via a GUI. For example, selection input 216 comprising target text may be identified by TIM 206 based on user input 210 received in environment 212-2.

Continuing to block 532 “determine two or more objects of interest in the target text based on analysis of the target text with one or more machine learning algorithms” two or more objects of interest may be identified based on analysis of the target text with one or more machine learning algorithms. For example, objects of interest 222-1 and 222-2 may be identified in selection input 216 by TIM 206 via analysis of selection input 216 with one or more machine learning algorithms.

Proceeding to block 534 “assign one or more classifications to each of the two or more objects of interest in the target text based on analysis of the target text with the one or more machine learning algorithms” one or more classifications may be assigned to each of the two or more objects of interest in the target text based on analysis of the target text with one or more machine learning algorithms. For instance, text analyzer 430 may assign classifications 424-1 to object of interest 422-1 and classifications 424-2 to object of interest 424-2 based on analysis of selection input with one or more machine learning algorithms.

At block 536 “store indications of the two or more objects of interest in a clipboard datastore based on second input received in the first environment presented via the GUI” indications of the two or more objects of interest may be stored in a clipboard datastore based on second input received in the first environment presented via the GUI. For example, objects of interest 222-1, 222-2 may be stored in clipboard datastore 208 based on second input received in environment 212-2 via GUI 204. In some such examples, the second input may comprise user confirmation of the identified objects of interest.

At block 538 “store indications of the one or more classifications of each of the two or more objects of interest in the clipboard datastore based on the second input received in the first environment presented via the GUI” indications of the one or more classifications for each of the two or more objects of interest may be stored in the clipboard datastore based on the second input received in the first environment presented via the GUI. For example, classifications 224-1, 224-2 may be stored with objects of interest 222-1, 222-2, respectively, in clipboard datastore 208 based on second input received in environment 212-2 via GUI 204. In some such examples, the second input may comprise user confirmation of the identified objects of interest and the classifications of the identified objects of interest.

Continuing to block 540 “present, via the GUI, first and second classifications assigned to a first object of interest of the one or more objects of interest based on third input received in a second environment presented via the GUI” first and second classifications assigned to the first object of interest and a second classification assigned to a second object of interest may be presented, via the GUI, based on third input received in a second environment presented via the GUI. For instance, presenter 426 may present object of interest 422-2 with a bank account number classification and a confidential classification in environment 212-2 based on user input selecting a first interface element of interface elements 214-n. In some embodiments, the confidential classification may be presented by replacing one or more digits of the bank account number with asterisks.

At block 542 “insert the first object of interest into the second environment presented via the GUI based on fourth input received in the second environment presented via the GUI” the first object of interest may be inserted into the second environment presented via the GUI based on fourth input received in the second environment. For example, object of interest 422-1 with the bank account number classification may be inserted into environment 212-n based on selection of object of interest 422-1 via user input.

FIG. 5C illustrates one embodiment of a logic flow 500C, which may be representative of operations that may be executed in various embodiments in conjunction with techniques for transferring data within and between computing environments. The logic flow 500C may be representative of some or all of the operations that may be executed by one or more components/devices/environments described herein, such as GUI 104, TIM 106, and/or clipboard datastore 108. The embodiments are not limited in this context.

In the illustrated embodiments, logic flow 500C may begin at block 550. At block 550 “identifying target text based on first input received in a first environment presented via a graphical user interface (GUI)” target text may be identified based on first input received in a first environment presented via a GUI. For example, selection input 216 comprising target text may be identified by TIM 206 based on user input 210 received in environment 212-2.

Continuing to block 552 “determining two or more objects of interest in the target text based on analysis of the target text with one or more machine learning algorithms” two or more objects of interest may be identified based on analysis of the target text with one or more machine learning algorithms. For example, objects of interest 222-1 and 222-2 may be identified in selection input 216 by TIM 206 via analysis of selection input 216 with one or more machine learning algorithms.

Proceeding to block 554 “assigning one or more classifications to each of the two or more objects of interest in the target text based on analysis of the target text with the one or more machine learning algorithms” one or more classifications may be assigned to each of the two or more objects of interest in the target text based on analysis of the target text with one or more machine learning algorithms. For instance, text analyzer 430 may assign classifications 424-1 to object of interest 422-1 and classifications 424-2 to object of interest 424-2 based on analysis of selection input with one or more machine learning algorithms.

At block 556 “storing indications of the two or more objects of interest in a clipboard datastore based on second input received in the first environment presented via the GUI” indications of the two or more objects of interest may be stored in a clipboard datastore based on second input received in the first environment presented via the GUI. For example, objects of interest 222-1, 222-2 may be stored in clipboard datastore 208 based on second input received in environment 212-2 via GUI 204. In some such examples, the second input may comprise user confirmation of the identified objects of interest.

At block 558 “storing indications of the one or more classifications of each of the two or more objects of interest in the clipboard datastore based on the second input received in the first environment presented via the GUI” indications of the one or more classifications for each of the two or more objects of interest may be stored in the clipboard datastore based on the second input received in the first environment presented via the GUI. For example, classifications 224-1, 224-2 may be stored with objects of interest 222-1, 222-2, respectively, in clipboard datastore 208 based on second input received in environment 212-2 via GUI 204. In some such examples, the second input may comprise user confirmation of the identified objects of interest and the classifications of the identified objects of interest.

Continuing to block 560 “presenting, via the GUI, first and second objects of interest of the one or more objects of interest assigned to a first classification based on third input received in a second environment presented via the GUI” first and second objects of interest assigned to a first classification may be presented, via the GUI, based on third input received in a second environment presented via the GUI. For instance, presenter 426 may present objects of interest 222-1, 222-2 with a bank account number classifications in environment 212-2 based on user input selecting a first interface element of interface elements 214-n. In some embodiments, the bank account classifications may be presented with an account label classification. For example, in response to a user selecting the bank account classification in a menu (e.g., a menu created in response to a right click), object of interest 222-1 may be presented as checking account number and object of interest 222-2 may be presented as savings account number. In alternative embodiments, TIM 206 may automatically present only the checking account number based on destination contextual data indicating the destination is an auto draft set up website.

At block 562 “inserting the first and second objects of interest into the second environment presented via the GUI based on fourth input received in the second environment presented via the GUI” the first and second objects of interest may be inserted into the second environment presented via the GUI based on fourth input received in the second environment. For example, objects of interest 422-1, 422-2 with the bank account number classifications may be inserted into environment 212-n based on selection of object of interest 422-1 via user input. In such examples, object of interest 422-1 may be inserted into a first interface element and object of interest 422-2 may be inserted into a second interface element based on associations with checking and savings accounts, respectively, as well as corresponding contextual data indicating the first interface element is for input of a checking account number and the second interface element is for input of a savings account number.

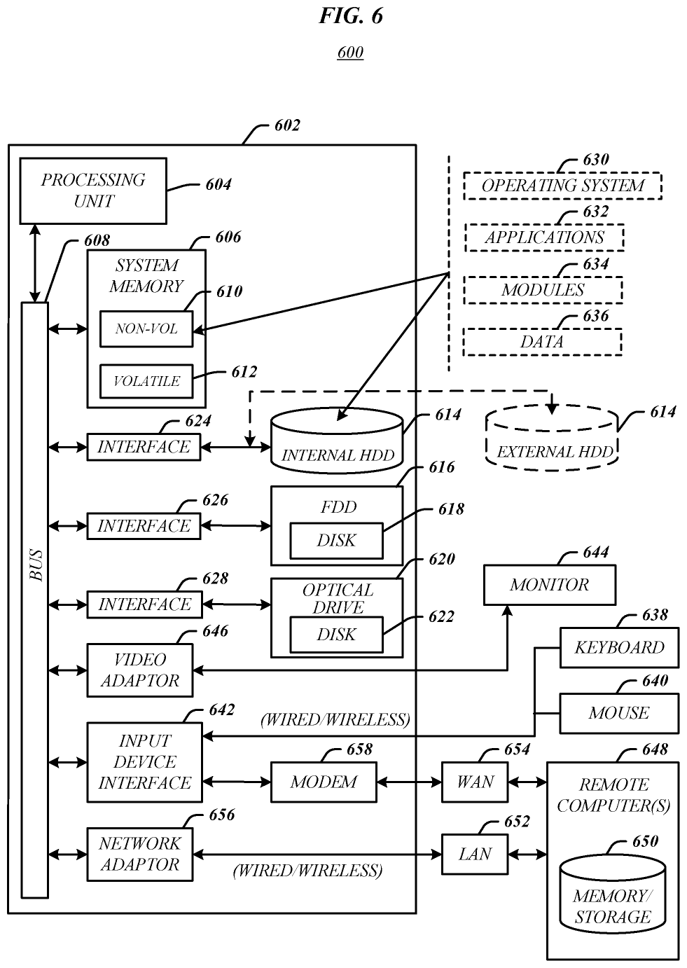

FIG. 6 illustrates an embodiment of an exemplary computing architecture 600 that may be suitable for implementing various embodiments as previously described. In various embodiments, the computing architecture 600 may comprise or be implemented as part of an electronic device. In some embodiments, the computing architecture 600 may be representative, for example, of one or more components described herein. In some embodiments, computing architecture 600 may be representative, for example, of a computing device that implements or utilizes one or more portions of components and/or techniques described herein, such as TIS 102, GUI 104, TIM 106, and/or clipboard datastore 108. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 600. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 600 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 600.

As shown in FIG. 6, the computing architecture 600 comprises a processing unit 604, a system memory 606 and a system bus 608. The processing unit 604 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 604.

The system bus 608 provides an interface for system components including, but not limited to, the system memory 606 to the processing unit 604. The system bus 608 can be any of several types of bus structure that may further interconnect to a memory bus (with or without a memory controller), a peripheral bus, and a local bus using any of a variety of commercially available bus architectures. Interface adapters may connect to the system bus 608 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 606 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 6, the system memory 606 can include non-volatile memory 610 and/or volatile memory 612. In some embodiments, system memory 606 may include main memory. A basic input/output system (BIOS) can be stored in the non-volatile memory 610.

The computer 602 may include various types of computer-readable storage media in the form of one or more lower speed memory units, including an internal (or external) hard disk drive (HDD) 614, a magnetic floppy disk drive (FDD) 616 to read from or write to a removable magnetic disk 618, and an optical disk drive 620 to read from or write to a removable optical disk 622 (e.g., a CD-ROM or DVD). The HDD 614, FDD 616 and optical disk drive 620 can be connected to the system bus 608 by an HDD interface 624, an FDD interface 626 and an optical drive interface 628, respectively. The HDD interface 624 for external drive implementations can include at least one or both of Universal Serial Bus (USB) and Institute of Electrical and Electronics Engineers (IEEE) 994 interface technologies. In various embodiments, these types of memory may not be included in main memory or system memory.

The drives and associated computer-readable media provide volatile and/or nonvolatile storage of data, data structures, computer-executable instructions, and so forth. For example, a number of program modules can be stored in the drives and memory units 610, 612, including an operating system 630, one or more application programs 632, other program modules 634, and program data 636. In one embodiment, the one or more application programs 632, other program modules 634, and program data 636 can include or implement, for example, the various techniques, applications, and/or components described herein.

A user can enter commands and information into the computer 602 through one or more wire/wireless input devices, for example, a keyboard 638 and a pointing device, such as a mouse 640. Other input devices may include microphones, infra-red (IR) remote controls, radio-frequency (RF) remote controls, game pads, stylus pens, card readers, dongles, fingerprint readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 604 through an input device interface 642 that is coupled to the system bus 608 but can be connected by other interfaces such as a parallel port, IEEE 994 serial port, a game port, a USB port, an IR interface, and so forth.

A monitor 644 or other type of display device is also connected to the system bus 608 via an interface, such as a video adaptor 646. The monitor 644 may be internal or external to the computer 602. In addition to the monitor 644, a computer typically includes other peripheral output devices, such as speakers, printers, and so forth.

The computer 602 may operate in a networked environment using logical connections via wire and/or wireless communications to one or more remote computers, such as a remote computer 648. In various embodiments, one or more interactions described herein may occur via the networked environment. The remote computer 648 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 650 is illustrated. The logical connections depicted include wire/wireless connectivity to a local area network (LAN) 652 and/or larger networks, for example, a wide area network (WAN) 654. Such LAN and WAN networking environments are commonplace in offices and companies, and facilitate enterprise-wide computer networks, such as intranets, all of which may connect to a global communications network, for example, the Internet.

When used in a LAN networking environment, the computer 602 is connected to the LAN 652 through a wire and/or wireless communication network interface or adaptor 656. The adaptor 656 can facilitate wire and/or wireless communications to the LAN 652, which may also include a wireless access point disposed thereon for communicating with the wireless functionality of the adaptor 656.

When used in a WAN networking environment, the computer 602 can include a modem 658, or is connected to a communications server on the WAN 654 or has other means for establishing communications over the WAN 654, such as by way of the Internet. The modem 658, which can be internal or external and a wire and/or wireless device, connects to the system bus 608 via the input device interface 642. In a networked environment, program modules depicted relative to the computer 602, or portions thereof, can be stored in the remote memory/storage device 650. It will be appreciated that the network connections shown are exemplary and other means of establishing a communications link between the computers can be used.

The computer 602 is operable to communicate with wire and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

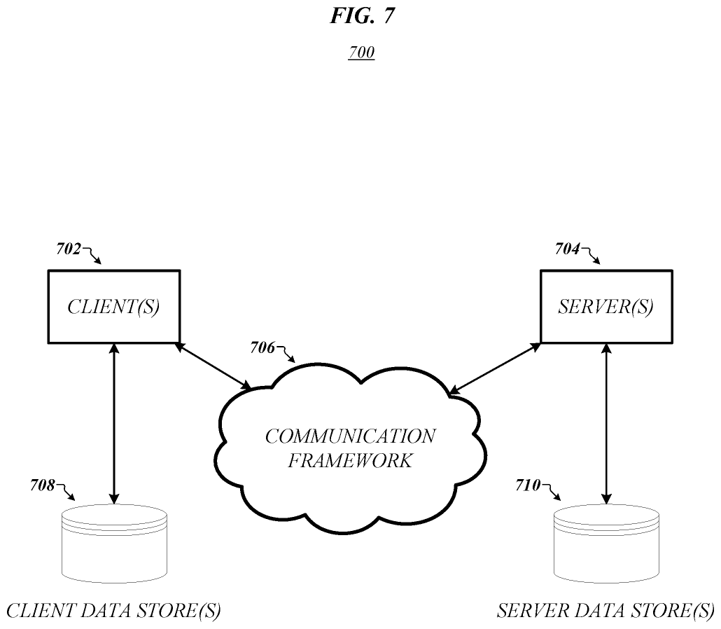

FIG. 7 illustrates a block diagram of an exemplary communications architecture 700 suitable for implementing various embodiments, techniques, interactions, and/or components described herein, such as TIS 102, GUI 104, TIM 106, and/or clipboard datastore 108. The communications architecture 700 includes various common communications elements, such as a transmitter, receiver, transceiver, radio, network interface, baseband processor, antenna, amplifiers, filters, power supplies, and so forth. The embodiments, however, are not limited to implementation by the communications architecture 700.

As shown in FIG. 7, the communications architecture 700 comprises includes one or more clients 702 and servers 704. In some embodiments, communications architecture may include or implement one or more portions of components, applications, and/or techniques described herein. The clients 702 and the servers 704 are operatively connected to one or more respective client data stores 708 and server data stores 710 that can be employed to store information local to the respective clients 702 and servers 704, such as cookies and/or associated contextual information. In various embodiments, any one of servers 704 may implement one or more of logic flows or operations described herein, such as in conjunction with storage of data received from any one of clients 702 on any of server data stores 710. In one or more embodiments, one or more of client data store(s) 708 or server data store(s) 710 may include memory accessible to one or more portions of components, applications, and/or techniques described herein.

The clients 702 and the servers 704 may communicate information between each other using a communication framework 706. The communications framework 706 may implement any well-known communications techniques and protocols. The communications framework 706 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 706 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1900 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 702 and the servers 704. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

1. An apparatus, comprising:
a processor; and
memory comprising instructions that when executed by the processor cause the processor to:
identify target text via first input received in a first environment presented via a graphical user interface (GUI);
analyze the target text with one or more machine learning algorithms in response to identification of the target text via the first input to determine two or more objects of interest in the target text, wherein each of the two or more objects of interest comprise different portions of the target text;
assign one or more classifications to each of the two or more objects of interest in the target text based on the analysis of the target text with the one or more machine learning algorithms;
store indications of the two or more objects of interest in a clipboard datastore based on second input received in the first environment presented via the GUI;
store indications of the one or more classifications of each of the two or more objects of interest in the clipboard datastore based on the second input received in the first environment presented via the GUI;
present, via the GUI, a first classification assigned to a first object of interest of the one or more objects of interest and a second classification assigned to a second object of interest of the one or more objects of interest based on third input received in a second environment presented via the GUI; and
insert the first object of interest into the second environment presented via the GUI based on fourth input received in the second environment presented via the GUI.

2. The apparatus of claim 1, wherein the instructions, when executed by the processor, further cause the processor to:
identify first contextual data for the first environment;
analyze the target text and the first contextual data with the one or more machine learning algorithms to determine the two or more objects of interest in the target text; and
assign the one or more classifications to each of the two or more objects of interest in the target text based on the analysis of the target text and the first contextual data with the one or more machine learning algorithms.

3. The apparatus of claim 1, wherein the instructions, when executed by the processor, further cause the processor to:
identify second contextual data for the second environment; and
present, via the GUI, the first classification assigned to the first object of interest of the one or more objects of interest and the second classification assigned to the second object of interest of the one or more objects of interest based on the third input and the second contextual data, or
insert the first object of interest into the second environment based on fourth input and the second contextual data.

4. The apparatus of claim 1, wherein the instructions, when executed by the processor, further cause the processor to:
determine a setting associated with the first environment;
compare the setting associated with the first environment to the first classification of the first object of interest of the two or more objects of interest; and
store the indications of the first object of interest in the clipboard datastore based on comparison of the setting associated with the first environment and the first classification of the first object of interest.

5. The apparatus of claim 4, the setting associated with the first environment comprising a privacy privilege associated with the first environment and the first classification of the first object of interest comprising a privacy level associated with the first object of interest.

6. The apparatus of claim 5, the first object of interest comprising an account number or a social security number.

7. The apparatus of claim 1, wherein the instructions, when executed by the processor, further cause the processor to:
determine a setting associated with the first environment;
compare the setting associated with the first environment to a classification of a third object of interest determined in the target text; and
present, via the GUI, that indications of the third object of interest are blocked from storage in the clipboard datastore based on comparison of the setting associated with the first environment and the classification of the third object of interest.

8. The apparatus of claim 1, wherein the instructions, when executed by the processor, further cause the processor to:
determine a setting associated with the second environment;
compare the setting associated with the second environment to the first classification of the first object of interest of the two or more objects of interest; and
insert the first object of interest into the second environment presented via the GUI based on comparison of the setting associated with the second environment and the first classification of the first object of interest.

9. The apparatus of claim 1 wherein the instructions, when executed by the processor, further cause the processor to:
determine a setting associated with the second environment;
compare the setting associated with the second environment to a classification of a third object of interest determined in the target text; and
present, via the GUI, that indications of the third object of interest are blocked from insertion into the second environment based on comparison of the setting associated with the second environment and the classification of the third object of interest.

10. The apparatus of claim 1, wherein the instructions, when executed by the processor, further cause the processor to store indications of the two or more objects of interest to a first in, first out (FIFO) data structure in the clipboard datastore.

11. The apparatus of claim 1, the first environment comprising a first application and the second environment comprising a second application, wherein the first application is different than the second application.

12. The apparatus of claim 1, the first environment comprising a first window associated with an application and the second environment comprising a second window associated with the application.

13. At least one non-transitory computer-readable medium comprising a set of instructions that, in response to being executed by a processor circuit, cause the processor circuit to:
identify target text via first input received in a first environment presented via a graphical user interface (GUI);
analyze the target text with one or more machine learning algorithms in response to identification of the target text via the first input to determine two or more objects of interest in the target text, wherein each of the two or more objects of interest comprise different portions of the target text;
assign one or more classifications to each of the two or more objects of interest in the target text based on the analysis of the target text with the one or more machine learning algorithms;
store indications of the two or more objects of interest in a clipboard datastore based on second input received in the first environment presented via the GUI;
store indications of the one or more classifications of each of the two or more objects of interest in the clipboard datastore based on the second input received in the first environment presented via the GUI;
present, via the GUI, first and second classifications assigned to a first object of interest of the one or more objects of interest based on third input received in a second environment presented via the GUI; and
insert the first object of interest into the second environment presented via the GUI based on fourth input received in the second environment presented via the GUI.

14. The at least one non-transitory computer-readable medium of claim 13, comprising instructions that, in response to being executed by the processor circuit, cause the processor circuit to store the indications of the two or more objects of interest to a first in, first out (FIFO) data structure in the clipboard datastore.

15. The at least one non-transitory computer-readable medium of claim 13, the first environment comprising a first application and the second environment comprising a second application, wherein the first application is different than the second application.

16. The at least one non-transitory computer-readable medium of claim 13, the first environment comprising a first window associated with an application and the second environment comprising a second window associated with the application.

17. A computer-implemented method, comprising:
identifying target text via first input received in a first environment presented via a graphical user interface (GUI);
analyzing the target text with one or more machine learning algorithms in response to identification of the target text via the first input to determine two or more objects of interest in the target text, wherein each of the two or more objects of interest comprise different portions of the target text;
assigning one or more classifications to each of the two or more objects of interest in the target text based on the analysis of the target text with the one or more machine learning algorithms;
storing indications of the two or more objects of interest in a clipboard datastore based on second input received in the first environment presented via the GUI;
storing indications of the one or more classifications of each of the two or more objects of interest in the clipboard datastore based on the second input received in the first environment presented via the GUI;
presenting, via the GUI, first and second objects of interest of the one or more objects of interest assigned to a first classification based on third input received in a second environment presented via the GUI; and
inserting the first and second objects of interest into the second environment presented via the GUI based on fourth input received in the second environment presented via the GUI.

18. The computer-implemented method of claim 17, comprising:
determining a setting associated with the first environment;
comparing the setting associated with the first environment to the first classification of the first object of interest of the two or more objects of interest; and
storing an indication of the first object of interest in the clipboard datastore based on comparison of the setting associated with the first environment and the first classification of the first object of interest.

19. The computer-implemented method of claim 17, comprising:
determining a setting associated with the first environment;
comparing the setting associated with the first environment to a classification of a third object of interest determined in the target text; and
presenting, via the GUI, that indications of the third object of interest are blocked from storage in the clipboard datastore based on comparison of the setting associated with the first environment and the classification of the third object of interest.

20. The computer-implemented method of claim 17, comprising:
determining a setting associated with the second environment;
comparing the setting associated with the second environment to the first classification of the first object of interest of the two or more objects of interest; and
inserting the first object of interest into the second environment presented via the GUI based on comparison of the setting associated with the second environment and the first classification of the first object of interest.
